(19) United States
(12) Patent Application Publication
(10) Pub. No.: US 2025/0344241 A1
(43) Pub. Date: Nov. 6, 2025

(54) PRIORITIZED CHANNEL ACCESS FOR LOW LATENCY WIRELESS TRAFFIC

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Rui Cao, Sunnyvale, CA (US)

(21) Appl. No.: 19/197,715

(22) Filed: May 2, 2025

Related U.S. Application Data
(60) Provisional application No. 63/641,494, filed on May 2, 2024.
(60) Provisional application No. 63/642,913, filed on May 6, 2024.
(60) Provisional application No. 63/654,469, filed on May 31, 2024.
(60) Provisional application No. 63/672,541, filed on Jul. 17, 2024.
(60) Provisional application No. 63/682,401, filed on Aug. 13, 2024.
(60) Provisional application No. 63/700,092, filed on Sep. 27, 2024.
(60) Provisional application No. 63/738,447, filed on Dec. 23, 2024.

(51) Int. Cl. H04W 72/566; H04W 74/00

(52) U.S. Cl. CPC H04W 72/569; H04W 74/002

(57) ABSTRACT

Methods and apparatus for transmitting data (e.g., low latency data) by a wireless device. In a method, a wireless device determines to transmit a buffered data frame, and further determines that one or more conditions are met for utilizing Prioritized Enhanced Distributed Channel Access (P-EDCA) parameters to transmit the buffered data frame. The P-EDCA parameters include shortened backoff parameters in relation to legacy EDCA backoff parameters. The method additionally includes transmitting a defer signal (e.g., a Clear to Send frame) to initiate a P-EDCA contention window, and transmitting the data frame in accordance with the P-EDCA parameters for reception by a second wireless device. In certain embodiments, the P-EDCA contention window includes an RTS/CTS frame exchange with a second wireless device using the P-EDCA parameters.

### CROSS REFERENCE TO RELATED APPLICATIONS

The present U.S. Utility patent application claims priority pursuant to 35 U.S.C. § 119(c) to U.S. Provisional Application No. 63/641,494, entitled “LOW LATENCY AND FAIRNESS CONSIDERATION”, filed May 2, 2024, U.S. Provisional Application No. 63/642,913, entitled “PRIORITIZED CHANNEL ACCESS FOR LOW LATENCY TRAFFIC”, filed May 6, 2024, U.S. Provisional Application No. 63/654,469, entitled “LOW LATENCY AND FAIRNESS CONSIDERATION”, filed May 31, 2024, U.S. Provisional Application No. 63/672,541, entitled “PRIORITIZED CHANNEL ACCESS”, filed Jul. 17, 2024, U.S. Provisional Application No. 63/682,401, entitled “LOW LATENCY AND FAIRNESS CONSIDERATION”, filed Aug. 13, 2024, U.S. Provisional Application No. 63/700,092, entitled “HIGH PRIORITY ENHANCED DISTRIBUTED CHANNEL ACCESS (HIP EDCA)”, filed Sep. 27, 2024, and U.S. Provisional Application No. 63/738,447, entitled “LOW LATENCY SUPPORT”, filed Dec. 23, 2024, the contents of all of which are hereby incorporated herein by reference in their entirety and made part of the present U.S. Utility patent application for all purposes.

### BACKGROUND

### Technical Field

This disclosure relates generally to wireless communications, and more specifically to prioritized channel access for low latency data.

### Description of Related Art

Wireless local area networks (WLANs) have evolved rapidly over the past couple of decades, including WLANs that conform to the Institute of Electrical and Electronics Engineers (IEEE) 802.11 family of standards. A typical 802.11-based WLAN is formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

In such WLANs, an AP or a STA (e.g., a non-AP STA) transmits data within a Transmit Opportunity (TXOP) after it has gained access to a wireless medium. In general, a TXOP is a designated time duration (following channel contention) for which the AP/STA can transmit frames, essentially giving it exclusive access to the wireless medium (or channel) for a set duration without needing to compete with other devices in a BSS. For example, an AP can transmit multiple frames during a TXOP without interruption, thereby allowing the AP to provide Quality of Service (QOS) for delay sensitive/low latency applications such as voice or video.

The IEEE 802.11 standard further defines a Request to Send/Clear to Send (RTS/CTS) mechanism intended to reduce frame collisions and manage wireless medium access. In conventional operation, when a STA/AP wants to transmit data, it first sends an RTS frame to the intended recipient. The RTS frame includes information about the duration of the proposed data transmission and any subsequent acknowledgements (ACKs). Upon receiving the RTS frame, the recipient waits for a Short Interframe Space (SIFS) period and then responds with a CTS frame. The CTS frame repeats the duration information, thereby reserving the wireless medium for the specified time. Once the sender receives the CTS frame, it proceeds to send the actual data frames. Other stations in a BSS that overhear the RTS or CTS frames may set their Network Allocation Vector (NAV) timers to defer their transmissions for the duration specified in the RTS/CTS frames.

Enhanced Distributed Channel Access (EDCA), introduced in the IEEE 802.11e amendment to the IEEE 802.11 standard, is another mechanism to support QoS in wireless networks. EDCA prioritizes traffic by dividing it into four Access Categories (ACs): Voice (AC_VO), Video (AC_VI), Best Effort (AC_BE), and Background (AC_BK). Each of the four categories is assigned specific QoS parameters, such as Arbitration Inter-Frame Space (AIFS) parameters, Contention Window (CW) parameters, and TXOP parameters intended to improve efficient channel access and reduce congestion. The category differentiation is meant to allow real-time applications like voice and video to achieve lower latency and jitter as compared to other traffic types. Among other potential shortcomings, however, the number of STAs that can efficiently use EDCA ACs without leading to excessive tail-time latency and collisions is limited.

### BRIEF DESCRIPTION OF THE DRAWINGS

One or more embodiments will now be described by way of example only with reference to the accompanying drawings, in which:

FIG. 1 illustrates an example of a multi-link communications system in accordance with embodiments of the present disclosure;

FIG. 2 illustrates an example of a frame exchange sequence for prioritized channel access in accordance with an embodiment of the present disclosure;

FIG. 3 illustrates a frame exchange sequence in which collisions occur between defer signals and/or data frames from a first STA and a second STA;

FIG. 4 illustrates another example of a frame exchange sequence for prioritized channel access in accordance with an embodiment of the present disclosure;

FIG. 5 illustrates another example of a frame exchange sequence for prioritized channel access in accordance with an embodiment of the present disclosure;

FIG. 6 illustrates another example of a frame exchange sequence for prioritized channel access in accordance with an embodiment of the present disclosure;

FIG. 7 illustrates another example of a frame exchange sequence for prioritized channel access in accordance with an embodiment of the present disclosure;

FIG. 8 illustrates another example of a frame exchange sequence for prioritized channel access in accordance with an embodiment of the present disclosure;

FIG. 9 illustrates another example of a frame exchange sequence for prioritized channel access in accordance with an embodiment of the present disclosure;

FIG. 10 illustrates another example of a frame exchange sequence for prioritized channel access in accordance with an embodiment of the present disclosure;

FIG. 11 illustrates another example of a frame exchange sequence for prioritized channel access in accordance with an embodiment of the present disclosure;

FIG. 12 illustrates an example of a frame format of basic Trigger frame including a Preferred TID subfield in accordance with an embodiment of the present disclosure;

FIG. 13 illustrates an example of a frame exchange sequence including a Trigger frame, for prioritized channel access in accordance with an embodiment of the present disclosure;

FIG. 14 illustrates an example of a frame format of a Clear to Send (CTS) frame utilized as a defer signal (DS) in accordance with an embodiment of the present disclosure;

FIG. 15 illustrates an example of an EDCA contention period involving defer signals;

FIG. 16 is a flow chart illustrating an example method for transmitting low latency data in accordance with an embodiment of the present disclosure; and

FIG. 17 illustrates an example of an access point or station according to an embodiment of the present disclosure.

### DETAILED DESCRIPTION

The various implementations described in the following description relate generally to new and innovative techniques for prioritized wireless channel access for low latency data (e.g., certain voice and video-related data traffic). More particularly, frame exchange sequences and wireless channel reservation parameters are described for transmitting low latency data frames. In various examples, a wireless device having buffered low latency data determines that one or more conditions are met for utilizing Prioritized Enhanced Distributed Channel Access (P-EDCA) parameters to transmit the buffered low latency data frame. The P-EDCA parameters include aggressive/shortened backoff parameters in relation to legacy EDCA backoff parameters. In an embodiment, a defer signal (e.g., a Clear to Send frame) is transmitted to initiate a P-EDCA contention window, following which a low latency data frame is transmitted in accordance with the P-EDCA parameters for reception by a second wireless device. In certain embodiments, the P-EDCA contention window includes an RTS/CTS frame exchange with a second wireless device using the P-EDCA parameters. In other embodiments, when specific conditions are satisfied, the buffered low latency data frame is transmitted without first transmitting a defer signal and/or a RTS/CTS frame exchange.

As used herein, the term “non-legacy” may refer to PPDU formats and communication protocols conforming with the IEEE 802.11bn amendment to the IEEE 802.11 standard (also referred to as “802.11bn”, “UHR” or “Wi-Fi 8”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, the channel reservation schemes described herein may support multiple versions of the IEEE 802.11 standard.

As may be used herein, the terms “low latency” and “low latency data” generally refer to high-priority traffic such as real-time voice and video data and/or data having a specific Access Category (e.g., AC_VO or AC_VI) or traffic identifier (TID), buffered data with a relatively short transmission delay bound that is less than a predetermined threshold or, alternatively, buffered data that needs to be retransmitted following one or more failed transmissions. As may further be used herein, the terms “prioritized access” and “prioritized channel access” relate to access to a transmission channel or medium based on aggressive/shortened channel access parameters, such as may be specified in a prioritized EDCA mechanism or “P-EDCA”. The P-EDCA parameter set allows for smaller Arbitration Interframe Space (AIFSN), CWmin, and CWmax values in relation to legacy EDCA parameters, enhancing transmission priority for STAs meeting specific conditions. After using P-EDCA, STAs may revert to normal/legacy EDCA parameters.

Particular implementations of the subject matter described in the present disclosure can be implemented to realize one or more of the following potential advantages over standard EDCA. By providing improved prioritized channel access through aggressive contention window (CW) management and adjusted interframe spaces, latency spikes and tail-time latency for low latency data frames/packets may be avoided and/or reduced, especially in high density deployments. Other advantages include greater fairness in handling channel access during periods of high channel contention, mitigating the possibility of frame collisions (e.g., with frames from hidden nodes) and frame retransmissions, and enhancing overall network performance.

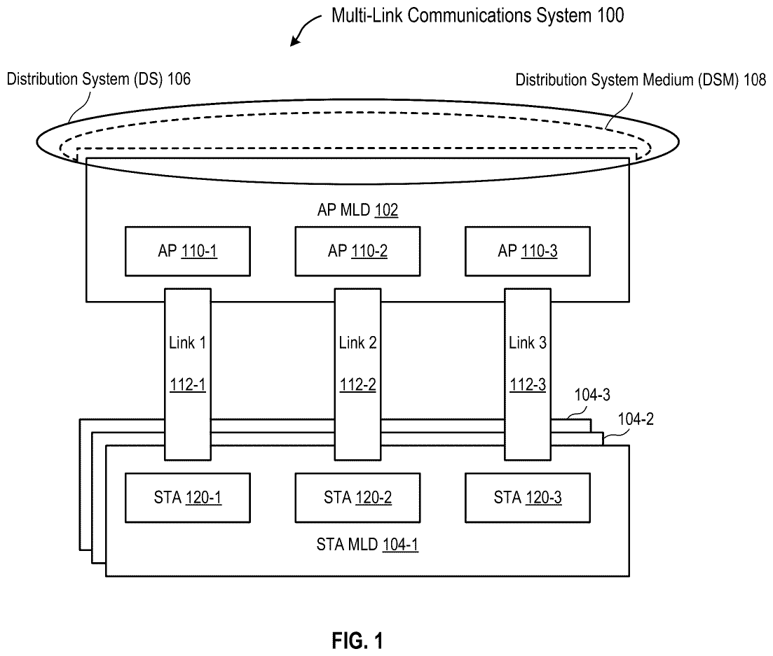

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices (which may also be referred to as a “non-AP MLD” or “STA MLD”), which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, a single AP MLD and a single STA MLD. In another example, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device. In some embodiments, a common part of the AP MLD 102 implements upper layer Media Access Control (MAC) functionalities (e.g., association establishment, reordering of frames, etc.) and a link specific part of the AP MLD 102, i.e., the APs 110-1, 110-2, and 110-3, implement lower layer MAC functionalities (e.g., backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 102 may operate in the same frequency band(s) or different frequency bands. For example, at least one of the APs 110-1, 110-2, or 110-3 of the AP MLD 102 operates in an Extremely High Frequency (EHF) band or the “millimeter wave (mmWave)” frequency band. In some embodiments, a mm Wave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 5 GHz band (e.g., with a 160 MHz BSS operating channel or other suitable BSS operating channel), and the AP 110-3 may operate in a 60 GHz band (e.g., with a 160 MHZ BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band(s) or different frequency bands. For example, at least one of the STAs 120-1, 120-2, or 120-3 of the STA MLD 104-1 operates in the mm Wave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 5 GHZ band (e.g., with a 160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less than three communications links. In some embodiments, the wireless communications links in the multi-link communications system include one or more 2.4 GHz, 5 GHZ, 6 GHZ, 45 GHz and/or 60 GHz links.

Various mechanisms are proposed herein for allowing a wireless device (e.g., a STA) to obtain prioritized access to a transmission medium. Briefly, and without limitation, such mechanisms include: an RTS frame transmission xIFS (e.g., DIFS) for low latency traffic transmission after the end of a TXOP and/or expiration of a NAV timer; a low latency Data frame transmission xIFS (e.g., DIFS) after the end of a TXOP; a defer signal (DS) transmission to initiate a P-EDCA contention window; a defer signal (DS) transmission followed by a Data frame transmission; etc. Each of these mechanisms may have one or more associated conditions that need to be met before the mechanism can be employed. For example, such conditions may relate to one or more of: a number of failed transmissions of low latency data; a frame length of the low latency data; expiration of a NAV timer(s); the end of a TXOP as indicated by a received frame; receipt of an CF-End frame; an Access Category or TID value associated with the low latency data; etc.

In various of the Figures described below, operation of Network Allocation Vector (NAV) timers is illustrated. Briefly, a NAV is a virtual carrier-sensing mechanism used in wireless networking protocols such as IEEE 802.11 to help manage access to a wireless medium/transmission channel. In operation, a NAV functions as a timer to indicate the duration for which a transmission channel will be occupied. In an example, when a STA receives a frame addressed to another device, it decodes a duration field in the frame header which specifies a time (e.g., in microseconds) required for the ongoing transmission and any subsequent acknowledgements. The STA then sets a NAV timer to this value, during which it refrains from attempting to access the transmission channel. A STA/AP may maintain multiple NAV timers, including a NAV timer(s) that handles channel reservations for frames received from an Overlapping BSS (OBSS) that utilizes the same transmission channel.

The P-EDCA parameters described herein can include, without limitation, a combination of AIFS, CWmin, CWmax, and TXOP parameters that is unique to at least one high-priority AC (e.g., AC_VO, or AV_VO and AC_VI). In an example, the P-EDCA parameters (or support for the P-EDCA parameters) are announced by an AP or otherwise determinable by a STA. In another example, a STA may announce support for P-EDCA parameters. A high-priority AC may have, for example, an associated enhanced distributed channel access function (e.g., EDCAF or P-EDCAF) that contends for TXOPs using the relevant set of EDCA/P-EDCA parameters.

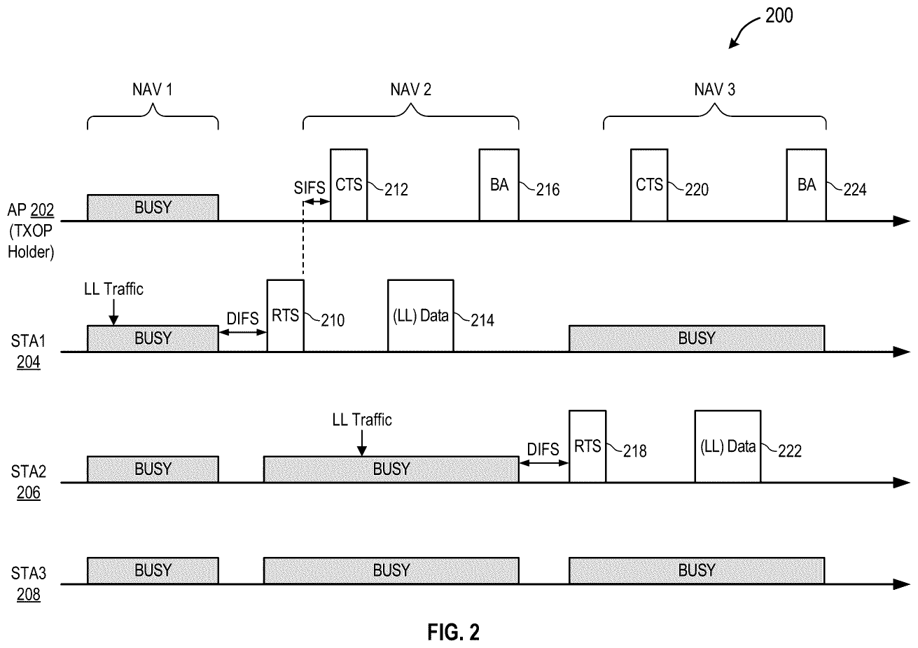

FIG. 2 illustrates an example of a frame exchange sequence 200 for prioritized channel access in accordance with an embodiment of the present disclosure. In this example, the frame exchange sequence does not rely on transmission of a defer signal. In the illustrated example, an AP 202 is a TXOP holder during a first NAV period (Nav 1). Following expiration of the TXOP, STA1 determines to access the transmission channel to transmit (buffered) low latency data. Expiration of the TXOP may be indicated by one or more of expiration of a NAV 1 timer, reception of a frame indicating the end of the TXOP (e.g., a CF-End frame), reception of a frame with the TXOP field equal to 0, or reception of a frame with the Duration field equal to 0.

In this example, STA 1 determines that one or more conditions are satisfied for prioritized channel access, and transmits an RTS frame 210 xIFS (e.g., DIFS) after the end of the TXOP. The RTS frame 210 initiates a second NAV period (NAV 2) and causes STA2 206 and STA3 208 to assess the channel as busy. The AP 202 responds to the RTS frame 210 by transmitting a CTS frame 212 following a SIFS. After receiving the CTS frame 212, STA1 transmits the buffered low latency (LL) data 214 and receives a responsive Block Acknowledgment (BA) 216. Following the end of the second NAV period of the illustrated example, STA2 206 determines that one or more conditions are satisfied for prioritized channel access and transmits an RTS frame 218. Upon receiving a responsive CTS 220 from AP 202, STA2 206 transmits its buffered LL data 222 and receives a BA 224 from AP 202.

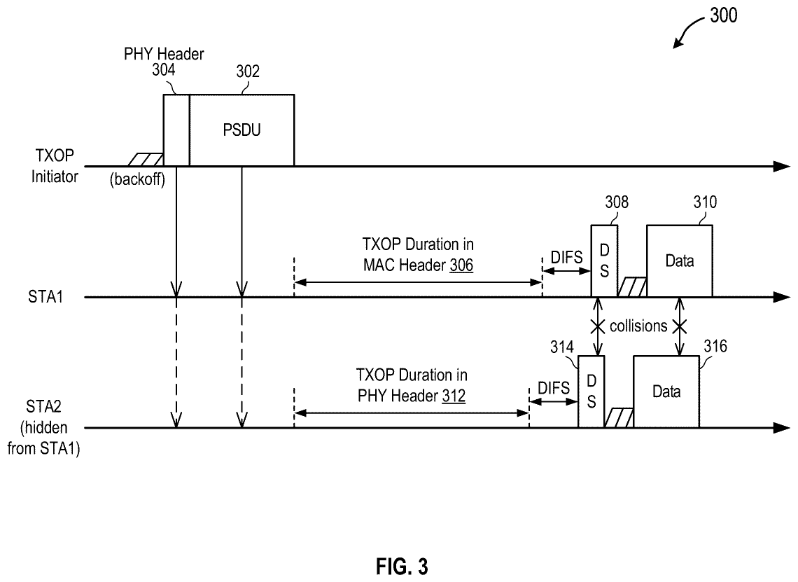

FIG. 3 illustrates a frame exchange sequence 300 in which potential collisions occur between defer signals and/or data frames transmitted by a first STA and a second STA. In the illustrated example, a TXOP initiator (e.g., an AP) obtains a TXOP by transmitting a PPDU including a Physical Service Data Unit (PSDU) 302 and a PHY header 304. The PPDU may be, for example, a HE PPDU, an EHT PPDU, or an UHR PPDU. In this example, STA1 is able to obtain TXOP duration information 306 by decoding the Duration field (e.g., 16 bits) of a MAC header of PSDU 302. STA1 then waits for a DIFS period and transmits a defer signal (DS) 308 followed by low latency data 310. Continuing with this example, STA2 (which may be hidden from STA1) determines TXOP duration information 312 by decoding a TXOP field (e.g., 7 bits) of the PHY header 304. STA2 then waits for a DIFS period and transmits DS 314 followed by low latency data 316. An example of a Defer Signal (e.g., a CTS frame) used to delay the medium acceess of other STAs is described in conjunction with FIG. 14.

In the illustrated example, the TXOP duration information 306 and TXOP duration information 312 may be different due to the differing lengths of the fields from which the information is derived. As a result, the DS 308 and DS 314 may be misaligned in time, and may not be successfully received by another STA (e.g., an AP) even if the DS 308 and DS 314 have a unified frame format. In another (non-illustrated) example, a STA senses a transmission medium is busy but is unable to discern TXOP duration information. In this instance, if the STA determines to perform a random backoff AIFS after sensing the medium is idle transmits a DS and/or low latency data, collisions may arise. Such collisions may cause latency spikes and/or excessive tail-time latency for low latency data frames.

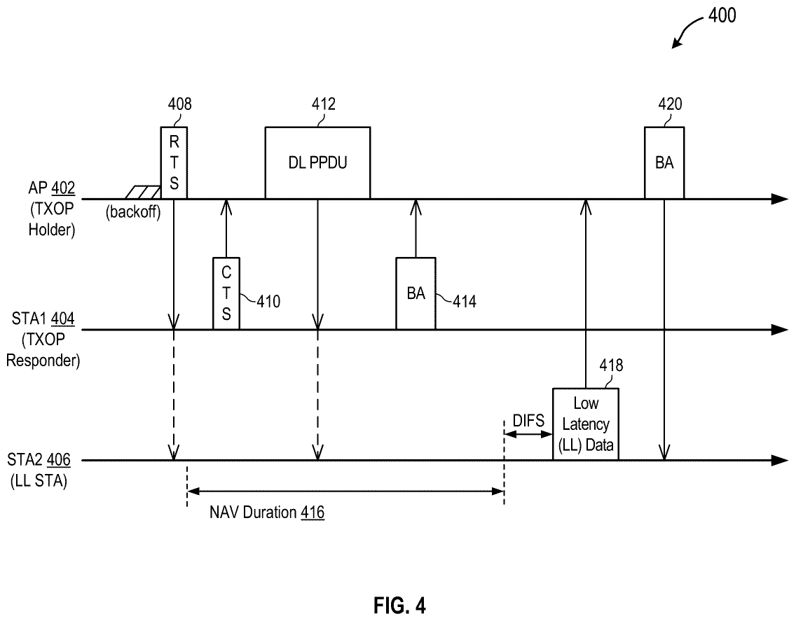

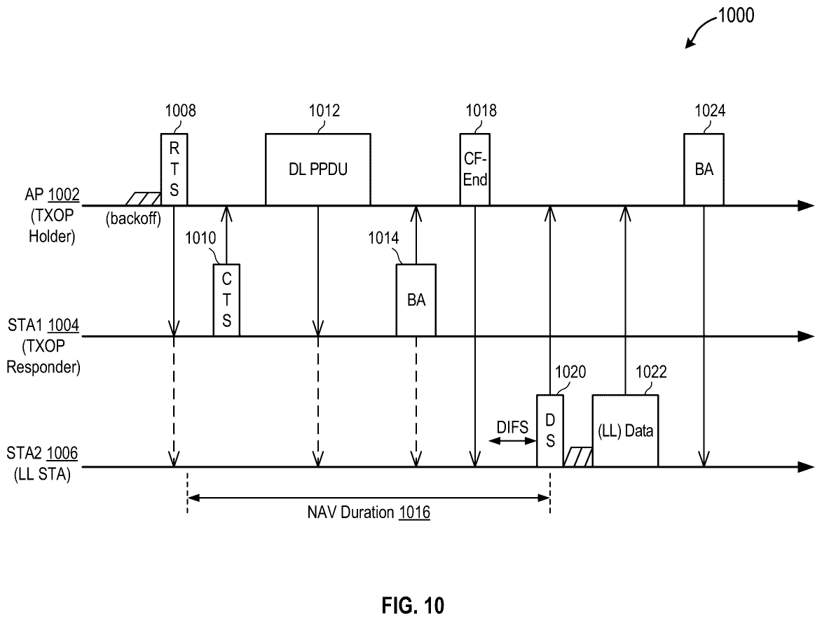

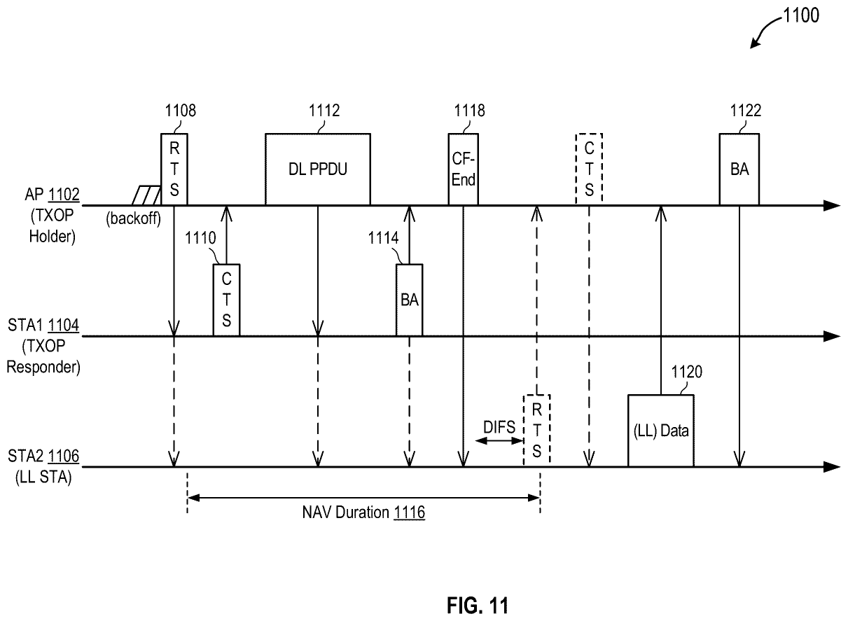

The potential challenges arising from unsynchronized delay signals that negatively affect medium access may be reduced or otherwise addressed in various of the frame exchange sequences described below. As described below, FIGS. 4-9 illustrate various frame exchange sequences for prioritized channel access following the expiration of one or more NAV (timer) durations, and FIGS. 10-11 illustrate various frame exchange sequences for prioritized channel access following receipt of a Contention-Free End (CF-END) frame.

FIG. 4 illustrates another example of a frame exchange sequence 400 for prioritized channel access in accordance with an embodiment of the present disclosure. In this example, a data frame is transmitted after the end of a TXOP without an EDCA backoff.

In the illustrated embodiment, an AP 402 (TXOP holder) transmits a Request to Send (RTS) frame 408, and receives a responsive Clear to Send (CTS) frame 410 from STA1 406 (TXOP Responder). AP 402 next transmits a DL PPDU 412, which is received and acknowledged by STA1 406 with Block Acknowledgement (BA) 414. In an example, BA 414 includes a MAC header having a Duration field set to zero. The RTS frame 408 of the illustrated example causes STA2 406 (e.g., a STA having low latency data to transmit) to set a NAV timer having a duration (416) that corresponds to the end of the TXOP. In this example, the NAV duration 416 may correspond to the end of a BSS TXOP initiated by a non-AP STA or an AP belonging to the same BSS.

In the illustrated example, STA2 406 waits for an xIFS (e.g., DIFS) time following expiration of a NAV (timer) duration 410, and transmits a PPDU including a low latency (LL) Data frame 418. In response to receiving the LL Data frame 418, AP 402 transmits a BA 420. As described above, if a defer signal (DS) is utilized, it may collide with other DSs from hidden nodes. However, when no collisions result (e.g., a single DS is transmitted), a random backoff after the DS may be unnecessary overhead.

In an example, the STA2 406 transmits the LL Data frame 418 without an EDCA backoff (and without first sending an RTS or defer signal) when it determines that a number of failed transmissions of the data frame exceeds a retransmission threshold number. The retransmission threshold may be announced, for example, by the associated AP 402. In a further example, when a data frame is waiting for transmission, a LL Failure Counter is set to 0. If a transmission of the data frame fails (e.g., due to a collision), the LL Failure Counter is incremented, and a contention window for retransmission is doubled. When the LL Failure Counter reaches a retransmission threshold number, an aggressive frame exchange sequence such as shown in FIG. 4 is invoked, and the LL Failure Counter is set to zero. In another example, aggressive P-EDCA backoff parameters (e.g., aggressive AIFSN and CWmin parameters) may be used for retransmission of the data frame.

In a further example, the LL Data frame 418 is (re) transmitted without an EDCA backoff if the length of the LL Data frame is less than predetermined threshold (e.g., a RTS/CTS protection threshold). If the length of the LL Data frame 418 is greater than the predetermined threshold, the STA2 406 may transmit a RTS/MU-RTS frame during a P-EDCA contention window, receive a responsive CTS frame, and attempt to retransmit LL Data frame 418.

In another example, an AP announces a length threshold (of a low latency Data frame) for RTS/CTS transmission prior to performing low latency frame exchanges. In this example, if the low latency Data frame is longer than the length threshold, after an aggressive backoff counter becomes zero the transmitter transmits an RTS frame to solicit a responsive CTS frame prior to transmission of the low latency Data frame. If the low latency Data frame is shorter than the length threshold, after the aggressive backoff counter becomes zero the CTS/RTS exchange is omitted. In a further example, the length threshold is less than a time required to perform an RTS/CTS exchange. In yet another example, the length threshold is determined by a transmitting AP/STA.

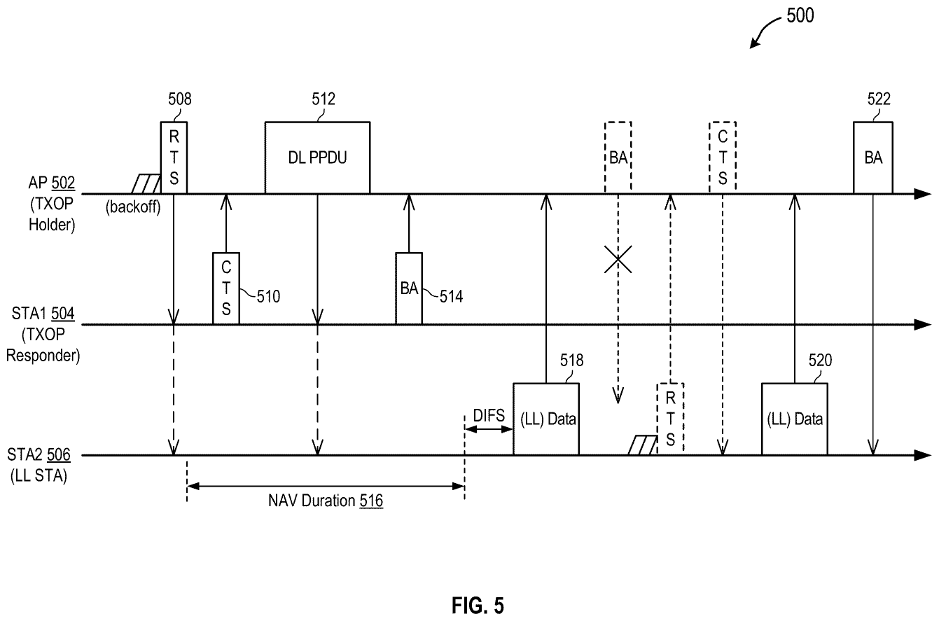

FIG. 5 illustrates another example of a frame exchange sequence 500 for prioritized channel access in accordance with an embodiment of the present disclosure. In this example, a failed data frame transmission is utilized in lieu of a DS/RTS signal for a subsequent retransmission of the data frame. The RTS frame 508, CTS frame 510, DL PPDU 512 and BA 514 of this example are exchanged between AP 502 and STA1 504 as described above with reference to the similarly labeled elements 408-414 of FIG. 4.

In the illustrated example, STA2 506 waits for an XIFS (e.g., DIFS) time following expiration of a NAV (timer) duration 516, and then transmits a PPDU including a LL Data frame 518. In this example, the STA2 506 is not able to decode an acknowledgement for the LL data frame 518. In response, the STA2 506 determines to retransmit the LL data frame 518 using aggressive EDCA parameters (e.g., CWmin to set the contention window and no AIFS backoff). In an example, when the retransmission number for the LL data frame 518 is more than a retransmission threshold, the STA2 506 may contend for the medium by using a CWmin for low latency traffic as the CW to contend for the medium (aggressive backoff) until the low latency frame is transmitted successfully. In another example, the STA2 506 retransmits the LL Data frame 518 following a time of aSIFSTime+aSlotTime+aRXPhyStartDelay. Following a successful transmission of the LL Data frame 518, AP 502 transmits a BA 522.

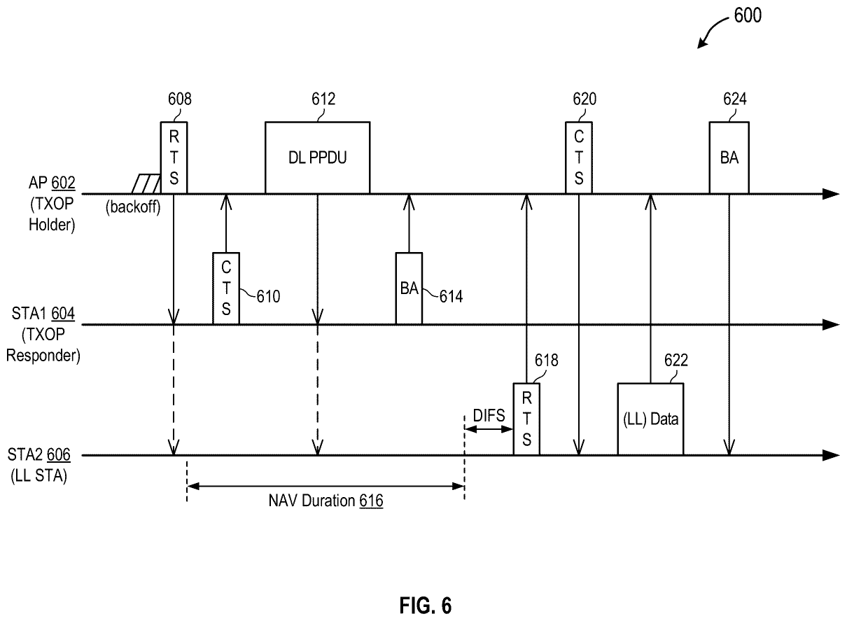

FIG. 6 illustrates another example of a frame exchange sequence 600 for prioritized channel access in accordance with an embodiment of the present disclosure. In this example, an RTS frame is transmitted after the end of a TXOP without an EDCA backoff. The RTS frame 608, CTS frame 610, DL PPDU 612 and BA 614 of this example are exchanged between AP 602 and STA1 604 as described above with reference to the similarly labeled elements 408-414 of FIG. 4.

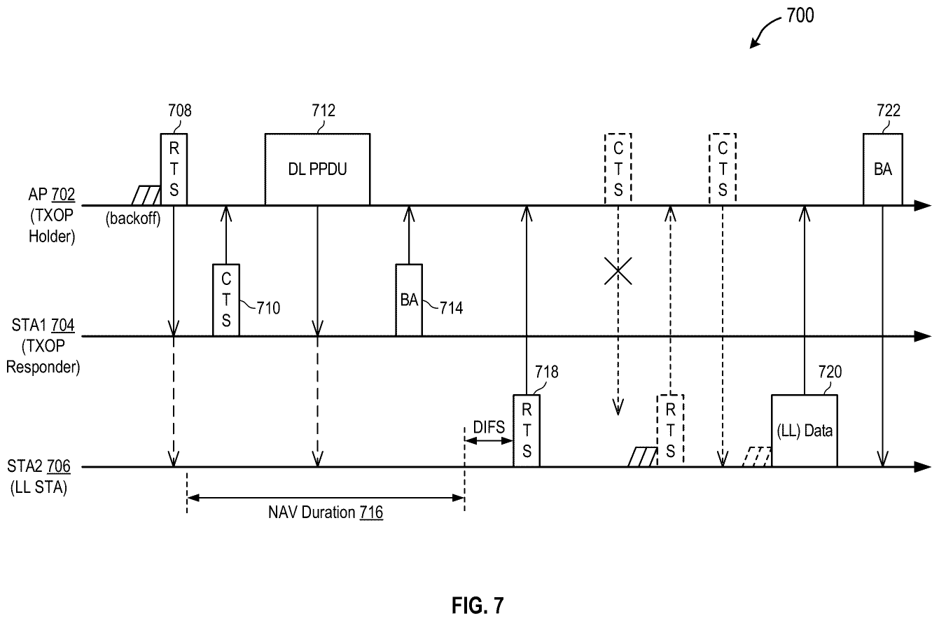

In the illustrated example, STA2 606 waits for an xIFS (e.g., DIFS) time following expiration of a NAV (timer) duration 616, and then transmits an RTS frame 618. The STA 606 receives a responsive CTS frame 620 from AP 602, and proceeds to transmit a LL data frame 622. If the transmission is successful, the AP 602 transmits a BA 624. If the transmission is unsuccessful, the STA2 606 may retransmit the LL data frame 622 using a procedure such as described in conjunction with FIG. 7.

FIG. 7 illustrates another example of a frame exchange sequence 700 for prioritized channel access in accordance with an embodiment of the present disclosure. In this example, if an RTS frame is transmitted without an EDCA backoff and a responsive CTS frame is not received, a data frame transmission is transmitted using an EDCA backoff with or without another RTS/CTS exchange. The RTS frame 708, CTS frame 710, DL PPDU 712 and BA 714 of this example are exchanged between AP 702 and STA1 704 as described above with reference to the similarly labeled elements 408-414 of FIG. 4.

In the illustrated example, STA2 706 waits for an xIFS (e.g., DIFS) time following expiration of a NAV (timer) duration 716, and then transmits an RTS frame 618. In this example, the STA2 706 does not receive/decode a responsive CTS frame within the expected time period. In lieu of another attempt at an RTS/CTS exchange, the failed RTS frame 618 is effectively treated as a defer signal and the STA2 706 determines to transmit a LL data frame 720 (e.g., using a current contention window or the exponential EDCA backoff). In an example, the STA2 706 determines to transmit the LL data frame 720 without a successful RTS/CTS exchange when the length of the LL data frame 720 is less than a predetermined threshold (otherwise, an RTS/CTS exchange is performed). In another example, the STA2 706 determines to transmit the LL data frame 720 without a successful RTS/CTS exchange when a number of failed transmissions of the LL data frame 720 exceeds a retransmission threshold number associated with P-EDCA parameters. During this time, other STAs may defer transmissions using Extended Interframe Space (EIFS) recovery. In yet another example, an RTS/CTS exchange is always performed prior to transmission of a low latency data frame.

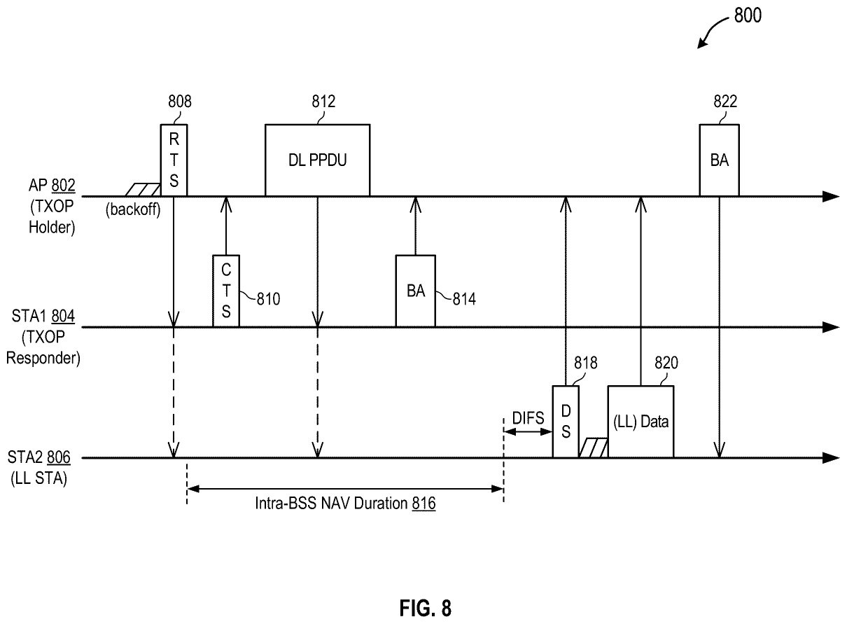

FIG. 8 illustrates another example of a frame exchange sequence 800 for prioritized channel access in accordance with an embodiment of the present disclosure. In this example, a defer signal (DS) is transmitted, after the end of a TXOP, without an EDCA backoff. The RTS frame 808, CTS frame 810, DL PPDU 812 and BA 814 of this example are exchanged between AP 802 and STA1 804 as described above with reference to the similarly labeled elements 408-414 of FIG. 4.

In the illustrated example, STA2 806 waits for an xIFS (e.g., DIFS) time following expiration of a NAV duration 816, and transmits a defer signal (DS) 818 (e.g., the DS-CTS frame of described with reference to FIG. 14). The STA2 then transmits a LL data frame 820 following a prioritized backoff time (e.g., CWmin) after DS 818. The AP 802 responds with a BA 822. In these examples, the TXOP may be a BSS TXOP initiated by a non-AP STA or an AP belonging to the same BSS, which may be helpful in reducing interference from DS frames transmitted by STAs from multiple OBSSs.

In an example, the STA transmits a DS-CTS (e.g., as an EDCA backoff) when it determines that a number of failed transmissions of a low latency data frame exceeds a retransmission threshold number associated with Prioritized Enhanced Distributed Channel Access (P-EDCA) parameters, the P-EDCA parameters including aggressive backoff and contention window parameters in relation to legacy EDCA parameters. In this example the threshold number may be announced by an associated AP. In an example, transmission of the DT-CTS may be further conditioned on the STA determining that the medium is idle DIFS after a first NAV timer (e.g., a basic NAV timer) and a second NAV timer (e.g., an intra-BSS NAV timer) count down to zero, or one of a first NAV timer (e.g., a basic NAV timer) and a second NAV time (e.g., an intra-BSS NAV timer) counts down to zero and another one of a first NAV timer (e.g., a basic NAV timer) and a second NAV timer (e.g., an intra-BSS NAV timer) has a zero value. In these examples, the STA may transmit the DS-CTS after a DIFS time (or an AIFS time announced by an associated AP) and transmit low latency data following an aggressive backoff time (CWmin).

In another example, the STA transmits a DS-CTS when it determines that a remaining time of a frame delay bound of the buffered low latency data frame is less than a predetermined threshold. The predetermined threshold may be announced, for example, by an associated AP. In a further example, the STA allowed to transmit a DS-CTS under a condition that it first determines that the medium is idle DIFS after a first NAV timer (e.g., a basic NAV timer) and a second NAV timer (e.g., an intra-BSS NAV timer) count down to zero or already have a value of zero. In these examples, the STA may transmit the DS-CTS after a DIFS time (or an AIFS time announced by an associated AP) and transmit low latency data following an aggressive backoff time (CWmin). The aggressive CW parameters may be announced by an associated AP. In a further example, the aggressive CW parameters may be applied for a pre-defined interval or pre-defined number of times before being reset to default EDCA parameters. In the foregoing examples, a pre-determined number of times may be different for different Access Classes (e.g., one retry for AC_VO, two retries for AC_VI, four retries for AC_BE, etc.).

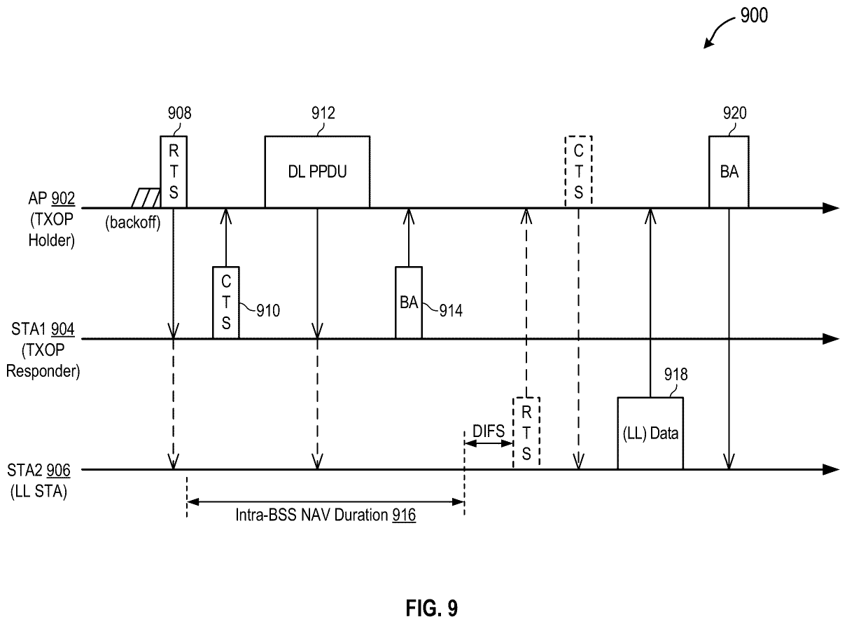

FIG. 9 illustrates another example of a frame exchange sequence 900 for prioritized channel access in accordance with an embodiment of the present disclosure. In this example, an RTS frame or low latency data is transmitted after the end of a TXOP without an EDCA backoff. The RTS frame 908, CTS frame 910, DL PPDU 912 and BA 914 of this example are exchanged between AP 902 and STA1 904 as described above with reference to the similarly labeled elements 408-414 of FIG. 4.

In the illustrated example, STA2 906 waits for an xIFS (e.g., DIFS) time following expiration of a NAV (timer) duration 916, and then transmits an RTS frame or, in another example, LL data frame 918. In these examples, the TXOP can be limited to an in-BSS TXOP.

FIG. 10 illustrates another example of a frame exchange sequence 1000 for prioritized channel access in accordance with an embodiment of the present disclosure. In this example, a defer signal is transmitted following receipt of a frame (e.g., a CF-END frame) indicating the end of a TXOP. The RTS frame 1008, CTS frame 1010, DL PPDU 1012 and BA 1014 of this example are exchanged between AP 1002 and STA1 1004 as described above with reference to the similarly labeled elements 408-414 of FIG. 4.

In the illustrated example, the AP 1002 transmits a Contention-Free End (CF-END) frame 1018 following receipt of a BA 1014 from STA1 1004. In other examples, the frame indicating the end of the TXOP may be a frame having a PHY header with a TXOP field set to zero or a frame having a MAC header with a Duration field set to zero (such a frame may optionally include padding information). In the illustrated example, the STA2 1006 waits for a DIFS time (or an AIFS time announced by an associated AP) following receipt of the CF-End frame 1018, and transmits a DS 1020. In an example, the DS 1020 may be transmitted prior to the expiration of NAV duration 1016. After transmitting the DS 1020, STA2 1006 waits for a backoff period (e.g., AIFS=0+BO) and transmits a LL data frame 1022. The AP 1002 responds to the LL data frame 1022 with a BA 1024.

In another example, if a STA supports prioritized channel access, and prioritized channel access is enabled within its BSS, an associated AP can announce that a TXOP holder is required or recommended to transmit a CF-END frame when a frame exchange is completed before the end of the TXOP. In this example, a STA that has buffered low latency traffic can perform prioritized channel access before the end of the TXOP after receiving the CF-END frame.

FIG. 11 illustrates another example of a frame exchange sequence 1100 for prioritized channel access in accordance with an embodiment of the present disclosure. In this example, low latency data is transmitted by a STA following receipt of a frame (e.g., a CF-END frame) indicating the end of a TXOP. The RTS frame 1108, CTS frame 1110, DL PPDU 1112 and BA 1114 are exchanged between AP 1102 and STA1 1104 as described above with reference to the similarly labeled elements 408-414 of FIG. 4.

In the illustrated example, the AP 1102 transmits a Contention-Free End (CF-END) frame 1118 following receipt of a BA 1014 from STA1 1004. In other examples, the frame indicating the end of the TXOP may be a frame having a PHY header with a TXOP field set to zero or a frame having a MAC header with a Duration field set to zero. In this example, STA2 1106 waits for an xIFS (e.g., DIFS) time following receipt of the CF-End frame 1118, and transmits LL data frame 1120 for receipt by AP 1102 (e.g., without a preceding RTS/CTS exchange and prior to expiration of NAV duration 1116). AP 1102 acknowledges receipt of the LL data frame 1120 with a BA 1122.

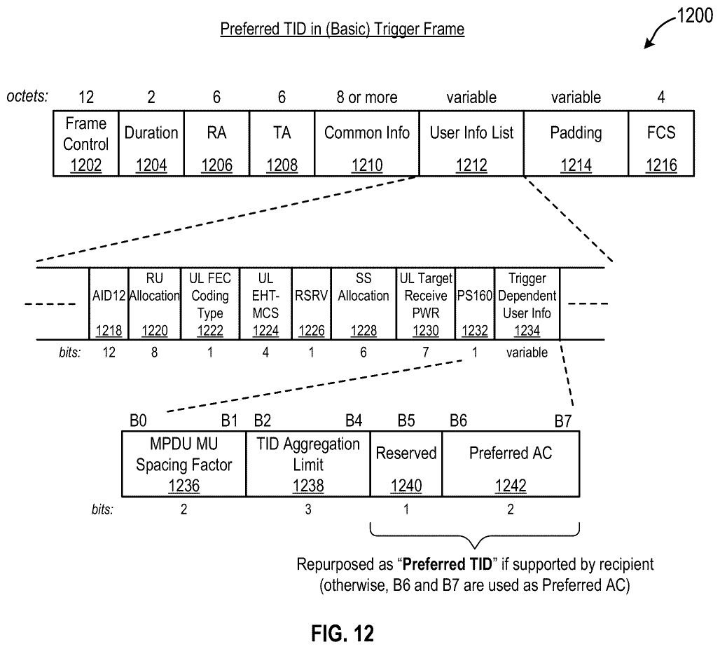

FIG. 12 illustrates an example of a frame format of basic Trigger frame 1200 including a Preferred TID subfield in accordance with an embodiment of the present disclosure. In this example, the Reserved subfield 1240 and the Preferred AC subfield 1242 of a User Info field are redefined to optionally include a Preferred TID value that may be used by a STA to identify data associated with the TID for prioritized channel access.

The illustrated Trigger frame 1200 includes a Frame Control field 1202, a Duration field 1204, a Receiver Address (RA) field 1206, a Transmitter Address (TA) field 1208, a Common Info field 1210, a User Info list field 1212, a Padding field 1214, and a Frame Check Sequence (FCS) field 1216. In this example, a User Info field of the User Info List field 1212 includes an AID 12 subfield 1218 consisting of 12 bits, an RU Allocation subfield 1220 consisting of 8 bits, a UL FEC Coding Type subfield 1222 consisting of 1 bit, a UL-EHT-MCS subfield 1224 consisting of 4 bits, a reserved bit 1226, an SS Allocation subfield 1228 consisting of 6 bits, a UL Target Receive Power subfield 1230 consisting of 7 bits, a PS160 subfield 1232 consisting of 1 bit, and a Trigger Dependent User Info subfield 1234. Additional (or modified) subfields may be included in the IEEE 802.11bn amendment to accommodate new features and capabilities while maintaining backwards compatibility with earlier versions of the 802.11 standard.

In the illustrated Trigger frame 1200, the Trigger Dependent User Info subfield 1234 includes an MPDU MU Spacing Factor subfield 1236 consisting of 2 bits, a TID Aggregation Limit subfield consisting of 3 bits, a Reserved bit 1240, and a Preferred AC subfield 1242 consisting of 2 bits. In this example, the Reserved bit 1240 and the Preferred AC subfield 1242 are re-defined to optionally (e.g., if supported by an addressed STA) a preferred TID value. In an example, the preferred TID value may be associated with low latency/high-priority traffic of an associated STA/AP.

In an example frame exchange sequence, a non-AP STA announces support for a Preferred TID in a Basic Trigger frame (e.g., as part of a Stream Classification Service (SCS) agreement or otherwise). A subsequent Basic Trigger frame addressed to the STA may then carry the Preferred TID subfield instead of a Preferred AC subfield in a User Info field addressed to the STA. In another example, a preferred TID(s) (e.g., a negotiated TID) is applied to part of a group of TIDs announced by a STA. A subsequent Basic Trigger frame addressed to the STA may then carry the Preferred TID subfield instead of a Preferred AC subfield if the preferred TID is one of the preferred TIDs announced by the STA. For scenarios involving a Restricted Target Wake Time (R-TWT) and service periods (SPs), the Preferred TID for a STA should match the TID of the R-TWT negotiated by the STA.

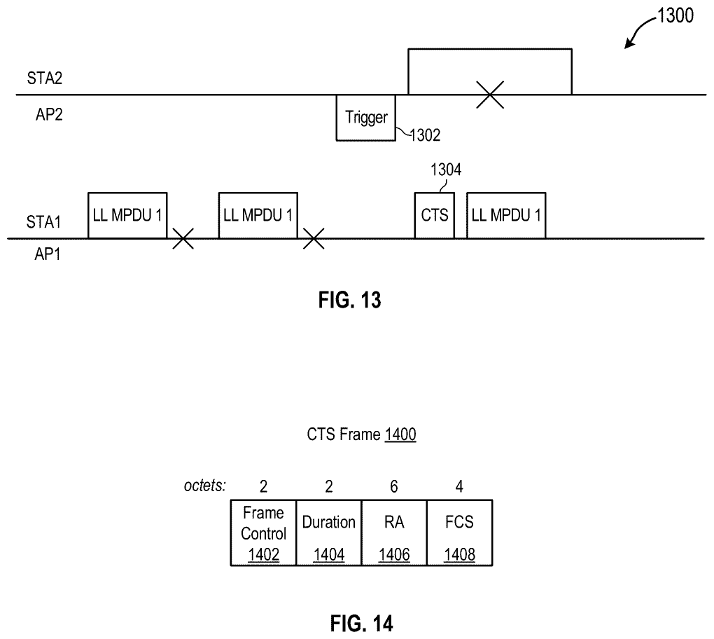

FIG. 13 illustrates an example of a frame exchange sequence 1300 including a Trigger frame (e.g., the Trigger frame of FIG. 12 or other Trigger frame) for prioritized channel access in accordance with an embodiment of the present disclosure. The Trigger frame 1302 of this example may include a User Info field addressed to the STA1/AP1 that carries a preferred TID value. The preferred TID value may be used by the STA1/AP1 to identify specific traffic/data to be (re) transmitted in the LL MPDU 1 (e.g., in accordance with P-EDCA parameters).

In the illustrated example, STA1/AP1 (e.g., in a low capability listening mode or eMLSR mode) unsuccessfully attempts to transmit a low latency (LL) MPDU 1 to STA2/AP2. Following the failed transmissions, STA1/AP1 receives Trigger frame 1302 from STA2/AP2, and is able to decode the Trigger frame 1302 to detect a PPDU ending time. In this example, STA1/AP1 supports a P-EDCA mechanism that allows it to retransmit LL MPDU 1 using an aggressive backoff under a condition that a PPDU ending time is first detected. Accordingly, in the illustrated example STA1/AP1 transmits a (DS-) CTS frame 1304 to STA2/AP2, and the retransmits LL MPDU1.

In a further example, a STA in a low capability listening is not allowed to perform aggressive backoff unless the STA detects a non-HT (duplicate) PPDU and decodes its MAC header Duration field having a valid duration value, or detects and decodes the TXOP field in a PHY header of a PPDU. In another example, a STA in an eMLSR mode is not allowed to perform aggressive backoff unless the STA detects a non-HT (duplicate) PPDU and decodes its MAC header Duration field having a valid duration value, or detects and decodes the TXOP field in a PHY header of a PPDU.

FIG. 14 illustrates an example of a frame format of a Clear to Send (CTS) frame 1400 utilized as a defer signal (also referred to herein as a “DS-CTS frame”) in accordance with an embodiment of the present disclosure. The illustrated DS-CTS frame 1400 includes a Frame Control field 1402, a Duration field 1404, a Receiver Address (RA) field 1406, and an FCS field 1408.

In an example, the CTS frame 1400 is transmitted to an AP that is neither in a multiple BSSID set nor in a co-hosted AP set, or the CTS frame 1400 is transmitted by an AP that is neither in a multiple BSSID set nor in a co-hosted AP set. In such cases, the BSSID of the AP is used as the address in the RA field 1406 of the CTS frame 1400. In another example, the CTS frame 1400 is transmitted to an AP that belongs to a BSSID AP set or the CTS frame is transmitted by an AP that belongs to a BSSID AP set. In such cases, the transmitted BSSID of the Multiple BSSID set is used as the address in the RA field 1406. In a further example, the CTS frame 1400 is transmitted to an AP that belongs to a co-hosted AP set or the CTS frame 1400 is transmitted by an AP that belongs to a co-hosted AP set. In such cases, a reference BSSID, e.g., the smallest BSSID of the co-hosted APs in the co-hosted AP set, may be used as the address in the RA field 1406. In another example, the address of the RA field 1406 may be announced by an AP. Likewise, for an AP affiliated with an AP MLD in a seamless roaming domain, the address of the RA field 1406 of the CTS frame 1400 may be announced by the APs of the roaming domain (with the same value). In yet another example, a common MAC address may be defined in the 802.11bn amendment to the IEEE 802.11 standard for use in the RA field of DS-CTS frame.

In another example, the Duration field 1404 of the illustrated DS-CTS frame 1400 is set to a value announced by an associated AP. In this example, the virtual APs in one AP device are configured to announce the same duration value, and the APs in a single seamless remaining domain are configured to announce the same duration value. Alternatively, the value of the Duration field 1404 or a DS-CTS frame may have a value as defined in the 802.11bn amendment to the IEEE 802.11 standard.

In a further example, a scrambling initial value for the CTS frame 1400 (included in the SERVICE field of the PPDU carrying the CTS frame) is announced by an associated AP, e.g., in a Beacon, Probe Response, or Association Response frame. In this example, the virtual APs in one multiple BSSID set or co-hosted BSSID set announce the same scrambling initial value, and the APs affiliated with AP MLDs in a seamless roaming domain are configured to announce the same scrambling initial value. In yet another example, the scrambling initial value for a DS-CTS frame in the SERVICE field of the PPDU carrying the CTS frame has a value defined in the 802.11bn amendment to the IEEE 802.11 standard. In another example, the data rate of a PPDU carrying a DS-CTS frame has a value defined in the 802.11bn amendment to the IEEE 802.11 standard (e.g., 6 Mbps or another data rate). Similarly, the type of PPDU carrying a DS-CTS frame can be defined (e.g., a non-HT duplicate PPDU).

In addition, various conditions for transmitting a PPDU carrying a DS-CTS frame can be defined. In an example, for a primary channel, a STA may be required to perform channel assessment (to check for an idle channel) for an xIFS period (e.g., a SIFS or PIFS time) before transmitting the DS-CTS frame via the primary channel. For a secondary channel(s), channel assessment may be required for an xIFS period (e.g., SIFS or PIFS time) before transmitting the DS-CTS frame via the secondary channel. In another example, if a secondary channel(s) is idle and the combination of a primary channel and the second channel(s) satisfies a puncture requirement, the secondary channel(s) and the idle primary channel can be used to transmit the DS-CTS frame.

In a further example, the bandwidth (BW) of a PPDU (e.g., a non-HT duplicate PPDU) carrying a DS-CTS frame may be the expected BW of a subsequent PPDU carrying a low latency data frame(s), the same BW of a subsequent PPDU carrying a low latency data frame(s), or independent from the BW of a subsequent PPDU carrying a low latency data frame(s) (in which case a BW of 20 MHz is used to transmit the DS-CTS frame). In another example, although the DS-CTS frame is transmitted in a non-HT duplicate PPDU with a BW greater than 20 MHz, a BW indicator value in a SERVICE field of the non-HT duplicate PPDU carrying the DS-CTS indicates a 20 MHz BW.

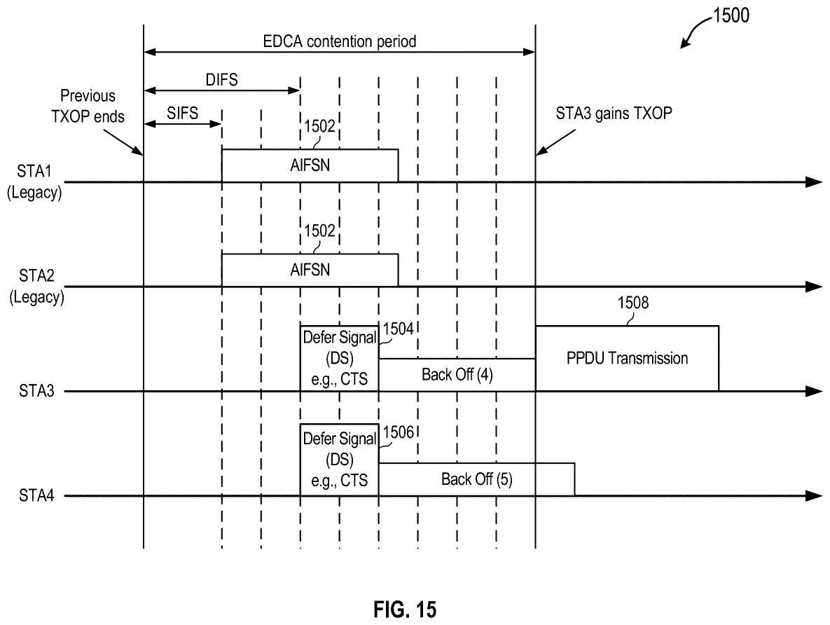

FIG. 15 illustrates an example of an EDCA contention period 1500 involving defer signals. In the illustrated example, first and second legacy stations STA1 and STA2 and stations STA3 and STA4 are competing for channel access during an EDCA contention period (e.g., a P-EDCA contention period) that follows the end of a TXOP. In this example, STA1 and STA2 contend for channel access using baseline EDCA parameters. In particular, each of STA1 and STA2 are required to wait for a minimum time (equal to an Arbitration Interframe Space Number (AIFSN)×Slot Time+SIFS period of time) before attempting to transmit over the channel if it is otherwise idle. Each AIFSN 1502 is specific to an Access Category of traffic, with higher-priority traffic having a shorter AIFSN than lower-priority traffic.

In the illustrated example, STA3 and STA4 may have buffered low latency data, and contend for channel access according to parameters of a Prioritized EDCA (P-EDCA) mechanism. In this example, each of STA3 and STA4 transmit a defer signal (DS) 1504 (e.g., a CTS frame, an RTS frame, in a STF/LTF or other field of a PPDU preamble) following a DIFS time after the end of a previous TXOP. The defer signals function to initiate a contention window (CW) (e.g., a P-EDCA contention window) between STA3 and STA4. STA1 and STA2 are effectively excluded from the contention window, as the defer signals cause these STAs to assess the channel as busy.

In this example, each of STA3 and STA4 further selects a random backoff time within its P-EDCA contention window (CW). The P-EDCA CW may operate within the general framework of, or use similar (but more aggressive) parameters to, a legacy EDCA mechanism. In an example, the P-EDCA CW is determined by a Minimum Contention Window (CWmin) value that defines a lower bound/smallest size of the contention window. Higher-priority traffic, for example, may use a relatively small (aggressive) CWmin value for faster channel access. In this example, the P-EDCA CW consists of a group of time slots defined by CWmin from which a random backoff time is selected. The P-EDCA CW is further determined by a Maximum Contention Window (CWmax) value that defines an upper bound/largest size of the contention window, and may be used in scenarios where medium contention escalates due to collisions.

In the illustrated example, STA3 selects a shorter random backoff time (4) than STA4 (5) and acquires the next TXOP. For example, STA3 acquires the TXOP through an RTS/CTS exchange (e.g., with an AP) that precedes the subsequent PPDU transmission 1508 including low latency data. Excluding STA1 and STA2 from the illustrated P-EDCA process may help minimize potential latency-related impacts of the EDCA exponential backoff mechanism, wherein the size of CW(s) may be doubled (backoff increment) in the event of a collision(s).

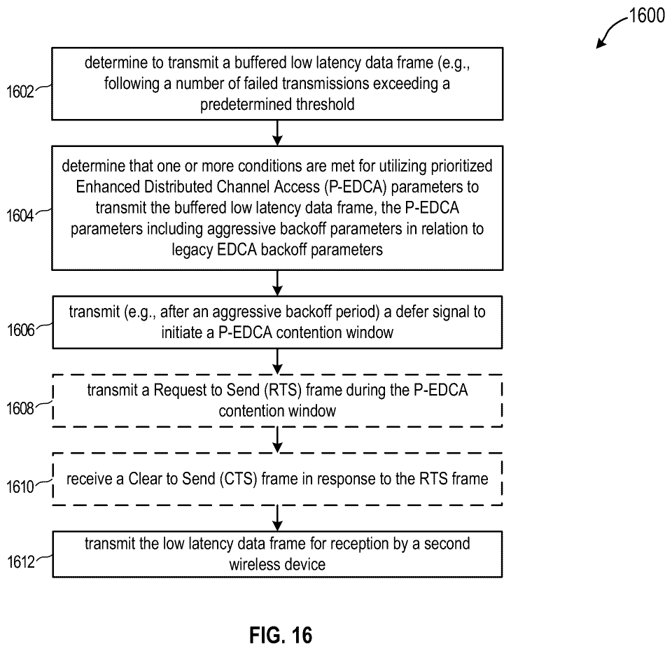

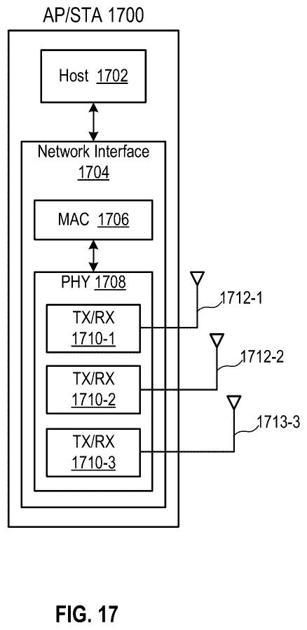

FIG. 16 is a flow diagram illustrating an example method 1600 for transmitting low latency data in accordance with an embodiment of the present disclosure. The method 1600 can be performed, for example, by an access point (AP) and/or station (STA), such as an AP/STA affiliated with the AP MLD 102 and the STA MLD 104 described with reference to FIG. 1, or the AP/STA 1700 described with reference to FIG. 17. The method 1600 may be utilized, for example, to a allow a device with latency-sensitive traffic to gain prioritized access to a wireless medium through the use of aggressive/prioritized EDCA parameters. The method begins at step 1602 where a first device determines to transmit a buffered low latency data frame. For example, the first device may have previously attempted to transmit the low latency data frame a number of times (e.g., exceeding a predetermined threshold number), and determine to retransmit the low latency data frame.

The method continues at step 1604, where the first device determines that one or more conditions are met for utilizing prioritized Enhanced Distributed Channel Access (P-EDCA) parameters to transmit the buffered low latency data frame. The P-EDCA parameters include, for example, aggressive (i.e., shortened) backoff parameters in relation to corresponding legacy EDCA backoff parameters. Following such an aggressive backoff period, the first device transmits (at step 1606) a defer signal (DS) to initiate a P-EDCA contention window. The method continues at step 1608, where the first device (in some embodiments) transmits a Request to Send (RTS) frame during the P-EDCA contention window. Following receipt of a responsive CTS frame at step 1610 (in some embodiments), the method continues at step 1606 where the first device transmits the low latency data frame for reception by a second wireless device.

FIG. 17 illustrates an example of a wireless device 1700 that is configured as an access point (AP) or station (STA) according to an embodiment of the present disclosure. The AP/STA 1700 is configurable to generate and receive frames according to any of the various embodiments described herein, and to exchange initial control information with one or more other wireless devices. The illustrated AP/STA 1700 includes a host processor 1702 coupled to a network interface device 1704. The network interface device 1704 includes a medium access control (MAC) processing unit 1706 and a physical layer (PHY) processing unit 1708. The PHY processing unit 1708 includes a plurality of transceivers 1710 coupled to a plurality of antennas 1712. Although three transceivers 1710 (1710-1, 1710-2 and 1710-3) and three antennas 1712 (1712-1, 1712-2 and 1712-3) are illustrated in FIG. 17, the AP 1700/STA includes other suitable numbers (e.g., 1, 2, 4, 5, etc.) of transceivers 1710 and antennas 1712 in other embodiments. In an example, the MAC processing unit 1706 and the PHY processing unit 1708 are configured to operate in compliance with the IEEE 802.11bn amendment to the IEEE 802.11 standard. In an example, the network interface device 1704 includes one or more integrated circuit (IC) devices. In this example, at least some of the functionality of the MAC processing unit 1706 and at least some of the functionality of the PHY processing unit 1708 can be implemented on a single IC device. As another example, at least some of the functionality of the MAC processing unit 1706 is implemented on a first IC device, and at least some of the functionality of the PHY processing unit 1708 is implemented on a second IC device. The AP/STA 1700 may communicate (e.g., C-TDMA related communications) with a plurality of client stations and other APs, including both legacy and non-legacy client APs and stations.

In various embodiments, the PHY processing unit 1708 of the AP/STA 1700 is configured to generate data units conforming to a non-legacy communication protocol and having formats described herein. The transceiver(s) 1710 is/are configured to transmit the generated data units via the antenna(s) 1712. Similarly, the transceiver(s) 1710 is/are configured to receive data units via the antenna(s) 1712. The PHY processing unit 1708 of the AP/STA 1700 is configured to process received data units conforming to the non-legacy communication protocol and having formats described herein and to determine that such data units conform to the non-legacy communication protocol.

In an embodiment, when operating in single-user mode, the AP/STA 1700 transmits a data unit to a single client station (DL SU transmission), or receives a data unit transmitted by a single client station (UL SU transmission), without simultaneous transmission to, or by, any other client station. When operating in multi-user mode, the AP/STA 1700 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP/STA 1700 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP/STA 1700 may be configured as a multi-link device, such as the AP MLD 102 or the STA MLD 104 described above with reference to FIG. 1.

While the innovate aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative prioritized channel reservations mechanisms illustrated in the drawings and described herein improve the performance of low latency traffic of a wireless network. In an illustrative, non-limiting embodiment, a method is provided for prioritized wireless channel access by a first wireless device. The method of this embodiment includes determining to transmit a buffered data frame (e.g., low latency data), and determining that one or more conditions are met for utilizing Prioritized Enhanced Distributed Channel Access (P-EDCA) parameters to transmit the buffered data frame. The P-EDCA parameters include shortened backoff parameters in relation to legacy EDCA backoff parameters. The method further includes transmitting a defer signal to initiate a P-EDCA contention window, and then transmitting the data frame in accordance with the P-EDCA parameters for reception by a second wireless device.

The method of this embodiment includes optional aspects. With one optional aspect, determining that one or more conditions are met for utilizing the P-EDCA parameters to transmit a buffered data frame includes determining a number of failed transmissions of the buffered data frame, and determining that the number of failed transmissions exceeds a retransmission threshold number associated with the P-EDCA parameters. In another optional aspect, determining that one or more conditions are met for utilizing the P-EDCA parameters includes comparing the length of the buffered data frame to a predetermined threshold and, in response to determining that the length of the buffered data frame is greater than a predetermined threshold, transmitting a Request to Send (RTS) frame during the P-EDCA contention window. This optional aspect further includes receiving a Clear to Send (CTS) frame prior to transmission of the data frame.

In another optional aspect, the defer signal is a Clear to Send (CTS) frame configured to indicate a pending transmission of data. In a further optional aspect, the CTS frame is transmitted in a non-HT duplicate PPDU having a bandwidth of 20 MHz, the CTS frame having a Receiver Address (RA) field corresponding to either the Basic Service Set Identifier (BSSID) of a transmitted BSSID AP when a STA transmitting the CTS frame is associated with an AP in the same BSSID AP set as the transmitted BSSID AP, or the BSSID of the transmitted BSSID AP when an AP transmitting the CTS frame is in the same BSSID AP set as the transmitted BSSID AP. In another optional aspect, the CTS frame is transmitted in a non-HT duplicate PPDU having a bandwidth of 20 MHZ, the CTS frame having an RA field corresponding to either the minimum BSSID in a co-hosted AP set when a station STA transmitting the CTS frame is associated with an AP in the co-hosted AP set, or the minimum BSSID in a co-hosted AP set when an AP transmitting the CTS frame is in the co-hosted AP set. In a further optional aspect, the CTS frame is transmitted in a non-HT duplicate PPDU having a bandwidth of 20 MHz, the CTS frame having a Receiver Address (RA) field corresponding to cither a BSSID of an AP when a station (STA) transmitting the CTS frame is associated with the AP, or the BSSID of an AP when the CTS frame is transmitted by the AP.

In another optional aspect, the CTS frame includes a Duration field and scrambling initial value having values defined in the 802.11be amendment to the IEEE 802.11 standard. In a further optional aspect, a scrambling initial value in a SERVICE field of a PPDU carrying the CTS frame has a value defined in the 802.11be amendment to the IEEE 802.11 standard. In another optional aspect, transmitting the defer signal includes determining that a transmission medium is idle for xIFS time after determining that one of the following conditions is met: one of a Basic NAV timer and an intra-BSS NAV timer becomes zero and the other of the Basic NAV timer and the intra-BSS NAV timer has a value of zero; or both the Basic NAV timer and the intra-BSS NAV timer become zero at the same time. In yet another optional aspect, the method further includes comparing the length of the buffered data frame to a predetermined threshold. In this optional aspect, in response to determining that the length of the buffered data frame is greater than the predetermined threshold, and prior to transmitting the data frame, transmitting a RTS frame during the P-EDCA contention window. This optional aspect further includes transmitting the data frame (without transmitting an RTS frame) in response to determining that the length of the buffered data frame is less than the predetermined threshold.

In another optional aspect, the data frame is identified by a predetermined traffic identifier (TID) value associated with low latency data. In yet another optional aspect, the frame has an associated Access Category (AC) of AC_VO. In a further optional aspect, determining to transmit the buffered data frame includes transmitting the data frame using the legacy EDCA backoff parameters, determining a failure of the transmission of the data frame using the legacy EDCA backoff parameters, and determining to retransmit the data frame using the P-EDCA parameters.

In another illustrative, non-limiting embodiment, a wireless device includes one or more wireless transceivers and one or more processors operably coupled to the one or more wireless transceivers. The one or more processors are arranged to execute operational instructions to determine to transmit a buffered data frame, and determine that one or more conditions are met for utilizing Prioritized Enhanced Distributed Channel Access (P-EDCA) parameters to transmit the buffered data frame. The P-EDCA parameters include shortened backoff parameters in relation to legacy EDCA backoff parameters. The one or more processors of the wireless device are further arranged to transmit, via the one or more wireless transceivers, a defer signal to initiate a P-EDCA contention window, and further transmit, via the one or more wireless transceivers, the data frame in accordance with the P-EDCA parameters for reception by a second wireless device.

The embodiment includes optional aspects. With one optional aspect, determining that one or more conditions are met for utilizing the P-EDCA parameters to transmit a buffered data frame includes determining a number of failed transmissions of the buffered data frame, determining that the number of failed transmissions exceeds a retransmission threshold number associated with the P-EDCA parameters. In another optional aspect, determining that one or more conditions are met for utilizing the P-EDCA parameters includes comparing the length of the buffered data frame to a predetermined threshold. In this optional aspect, in response to determining that the length of the buffered data frame is greater than a predetermined threshold, the one or more processors are further arranged to transmit, via the one or more wireless transceivers, a Request to Send (RTS) frame during the P-EDCA contention window, and receive, via the one or more wireless transceivers, a responsive Clear to Send (CTS) frame prior to transmission of the data frame.

In another optional aspect the defer signal is a Clear to Send (CTS) frame configured to indicate a pending transmission of low latency data. In a further optional aspect, transmitting the defer signal includes determining that a transmission medium is idle for xIFS time after determining that one of the following conditions is met: one of a Basic NAV timer and an intra-BSS NAV timer becomes zero and the other of the Basic NAV timer and the intra-BSS NAV timer has a value of zero; or both the Basic NAV timer and the intra-BSS NAV timer become zero at the same time. In yet another optional aspect, the data frame has an associated Access Category (AC) of AC_VO.

With another illustrative, non-limiting embodiment, a method is provided for prioritized channel access by a first wireless device. The method of this embodiment includes determining that a number of failed transmissions of a data frame exceeds a retransmission threshold number associated with Prioritized Enhanced Distributed Channel Access (P-EDCA) parameters. The P-EDCA parameters include shortened backoff and contention window parameters in relation to legacy EDCA parameters. The method further includes assessing that a transmission channel(s) is clear for at least a Short Inter-Frame Space, and transmitting a defer signal, via the transmission channel(s), to initiate a P-EDCA contention window. In this method, the first wireless device next transmits a Request to Send (RTS) frame during the P-EDCA contention window, and receives a Clear to Send (CTS) frame in response. The method further includes transmitting the data frame for reception by a second wireless device.

The method of this embodiment includes optional aspects. In one optional aspect, the defer signal is a Clear to Send (CTS) frame transmitted in a non-HT duplicate PPDU. In another optional aspect, the method further includes prior to assessing that a transmission channel(s) is clear, receiving at least one of a CF-End frame from a TXOP holder, a frame with a PHY header including a TXOP field set to zero, or a frame with a MAC header including a Duration field set to zero.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for prioritized wireless channel access, the method comprising:
determining to transmit a buffered data frame;
determining that one or more conditions are met for utilizing Prioritized Enhanced Distributed Channel Access (P-EDCA) parameters to transmit the buffered data frame, the P-EDCA parameters including shortened backoff parameters in relation to legacy EDCA backoff parameters;
transmitting a defer signal to initiate a P-EDCA contention window; and
transmitting the data frame in accordance with the P-EDCA parameters for reception by a second wireless device.

2. The method of claim 1, wherein determining that one or more conditions are met for utilizing the P-EDCA parameters to transmit a buffered data frame includes:
determining a number of failed transmissions of the buffered data frame; and
determining that the number of failed transmissions exceeds a retransmission threshold number associated with the P-EDCA parameters.

3. The method of claim 1, wherein determining that one or more conditions are met for utilizing the P-EDCA parameters includes:
comparing the length of the buffered data frame to a predetermined threshold,
in response to determining that the length of the buffered data frame is greater than a predetermined threshold:
transmitting a Request to Send (RTS) frame during the P-EDCA contention window; and
receiving a Clear to Send (CTS) frame prior to transmission of the data frame.

4. The method of claim 1, wherein the defer signal is a Clear to Send (CTS) frame, the CTS frame configured to indicate a pending transmission of low latency data.

5. The method of claim 4, wherein the CTS frame is transmitted in a non-High Throughput (non-HT) duplicate PPDU having a bandwidth of 20 MHz, the CTS frame having a Receiver Address (RA) field corresponding to either a Basic Service Set Identifier (BSSID) of a transmitted BSSID AP when a station (STA) transmitting the CTS frame is associated with an AP in the same BSSID AP set as the transmitted BSSID AP, or the BSSID of the transmitted BSSID AP when an AP transmitting the CTS frame is in the same BSSID AP set as the transmitted BSSID AP.

6. The method of claim 4, wherein the CTS frame is transmitted in a non-High Throughput (non-HT) duplicate PPDU having a bandwidth of 20 MHZ, the CTS frame having a Receiver Address (RA) field corresponding to either the minimum BSSID in a co-hosted AP set when a station (STA) transmitting the CTS frame is associated with an AP in the co-hosted AP set, or the minimum BSSID in a co-hosted AP set when an AP transmitting the CTS frame is in the co-hosted AP set.

7. The method of claim 4, wherein the CTS frame is transmitted in a non-High Throughput (non-HT) duplicate PPDU having a bandwidth of 20 MHz, the CTS frame having a Receiver Address (RA) field corresponding to either a BSSID of an AP when a station (STA) transmitting the CTS frame is associated with the AP, or the BSSID of an AP when the CTS frame is transmitted by the AP.

8. The method of claim 4, wherein the CTS frame includes a Duration field having a value defined in the 802.11be amendment to the IEEE 802.11 standard, and wherein the CTS frame further includes a scrambling initial value having a value defined in the 802.11be amendment to the IEEE 802.11 standard.

9. The method of claim 4, wherein a scrambling initial value in a SERVICE field of a PPDU carrying the CTS frame has a value defined in the 802.11be amendment to the IEEE 802.11 standard.

10. The method of claim 1, wherein transmitting the defer signal includes determining that a transmission medium is idle for xIFS time after determining that one of the following conditions is met:
one of a Basic Network Allocation Vector (NAV) timer and an intra-BSS NAV timer becomes zero and the other of the Basic NAV timer and the intra-BSS NAV timer has a value of zero; or
both the Basic NAV timer and the intra-BSS NAV timer become zero at the same time.

11. The method of claim 1, further comprising:
comparing the length of the buffered data frame to a predetermined threshold,
in response to determining that the length of the buffered data frame is greater than the predetermined threshold, prior to transmitting the data frame, transmitting a Request to Send (RTS) frame during the P-EDCA contention window; and
in response to determining that the length of the buffered data frame is less than the predetermined threshold, transmitting the data frame in accordance with the P-EDCA parameters for reception by the second wireless device.

12. The method of claim 1, wherein the data frame is identified by a predetermined traffic identifier (TID) value associated with low latency data.

13. The method of claim 1, wherein the data frame has an associated Access Category (AC) of AC_VO.

14. The method of claim 1, wherein determining to transmit the buffered data frame includes:
transmitting the data frame using the legacy EDCA backoff parameters;
determining a failure of the transmission of the data frame using the legacy EDCA backoff parameters; and
determining to retransmit the data frame using the P-EDCA parameters.

15. A wireless device, comprising:
one or more wireless transceivers; and
one or more processors operably coupled to the one or more wireless transceivers, wherein the one or more processors are arranged to:
determine to transmit a buffered data frame;
determine that one or more conditions are met for utilizing Prioritized Enhanced Distributed Channel Access (P-EDCA) parameters to transmit the buffered data frame, the P-EDCA parameters including shortened backoff parameters in relation to legacy EDCA backoff parameters;
transmit, via the one or more wireless transceivers, a defer signal to initiate a P-EDCA contention window; and
transmit, via the one or more wireless transceivers, the data frame in accordance with the P-EDCA parameters for reception by a second wireless device.

16. The wireless device of claim 15, wherein determining that one or more conditions are met for utilizing the P-EDCA parameters to transmit a buffered data frame includes:
determining a number of failed transmissions of the buffered data frame; and
determining that the number of failed transmissions exceeds a retransmission threshold number associated with the P-EDCA parameters.

17. The wireless device of claim 15, wherein determining that one or more conditions are met for utilizing the P-EDCA parameters includes:
comparing the length of the buffered data frame to a predetermined threshold,
in response to determining that the length of the buffered data frame is greater than a predetermined threshold:
transmit, via the one or more wireless transceivers, a Request to Send (RTS) frame during the P-EDCA contention window; and
receive, via the one or more wireless transceivers, a Clear to Send (CTS) frame prior to transmission of the data frame.

18. The wireless device of claim 15, wherein the defer signal is a Clear to Send (CTS) frame, the CTS frame configured to indicate a pending transmission of low latency data.

19. The wireless device of claim 15, wherein transmitting the defer signal includes determining that a transmission medium is idle for xIFS time after determining that one of the following conditions is met:
one of a Basic Network Allocation Vector (NAV) timer and an intra-BSS NAV timer become zero and the other of the Basic NAV timer and the intra-BSS NAV timer has a value of zero; or
both the Basic NAV timer and the intra-BSS NAV timer become zero at the same time.

20. The wireless device of claim 15, wherein the data frame has an associated Access Category (AC) of AC_VO.

21. A method for prioritized channel access by a first wireless device, the method comprising:
determining that a number of failed transmissions of a data frame exceeds a retransmission threshold number associated with Prioritized Enhanced Distributed Channel Access (P-EDCA) parameters, the P-EDCA parameters including shortened backoff and contention window parameters in relation to legacy EDCA parameters;
assessing that a transmission channel(s) is clear for at least a Short Inter-Frame Space;
transmitting a defer signal, via the transmission channel(s), to initiate a P-EDCA contention window;
transmitting a Request to Send (RTS) frame during the P-EDCA contention window;
receiving a Clear to Send (CTS) frame prior to transmission of the data frame; and
transmitting the data frame for reception by a second wireless device.

22. The method of claim 21, wherein the defer signal is a Clear to Send (CTS) frame transmitted in a non-High Throughput (non-HT) duplicate PPDU.

23. The method of claim 21, further comprising:
prior to assessing that a transmission channel(s) is clear, receiving at least one of:
a CF-End frame from a TXOP holder;
a frame with a PHY header including a TXOP field set to zero; or
a frame with a MAC header including a Duration field set to zero.
